(19) United States
(12) Patent Application Publication
(10) Pub. No.: US 2026/0184081 A1
(43) Pub. Date: Jul. 2, 2026

(54) INK REPLENISHMENT CONTAINER

(71) Applicant: SEIKO EPSON CORPORATION, Tokyo (JP)

(72) Inventors: Shun OYA, Kiso-machi (JP); Tadahiro MIZUTANI, Shiojiri-shi (JP); Tadashi WATANABE, Matsumoto-shi (JP); Yuta KOIKE, Matsumoto-shi (JP); Atsushi KOBAYASHI, Matsumoto-shi (JP)

(73) Assignee: SEIKO EPSON CORPORATION, Tokyo (JP)

(21) Appl. No.: 19/432,544

(22) Filed: Dec. 24, 2025

(30) Foreign Application Priority Data
Dec. 26, 2024 (JP) 2024-229924

(51) Int. Cl. B41J 2/175; B65D 47/08; B65D 47/24

(52) U.S. Cl. CPC B41J 2/17523; B41J 2/17553; B41J 2/17596; B65D 47/0885; B65D 47/247

(57) ABSTRACT

An ink replenishment container includes an ink outlet forming portion, a valve that brings an internal flow path into either a fluid communication state or a fluid non-communication state, and a cap, wherein the cap includes a projection that presses a valve body in a second direction in a sealed state, a projection end portion of the projection takes a valve-closed position in a detachment process of the cap, and the cap includes a snap-fit portion that is locked to the ink outlet forming portion by a snap-fit in the sealed state.

The present application is based on, and claims priority from JP Application Serial Number 2024-229924, filed Dec. 26, 2024, the disclosure of which is hereby incorporated by reference herein in its entirety.

### BACKGROUND

### 1. Technical Field

The present disclosure relates to an ink replenishment container.

### 2. Related Art

A known printer, which is an example of an ink ejecting apparatus, can perform printing on a print medium, such as printing paper, with ink by ejecting ink toward the print medium from a print head. Such printers include an ink replenishment-type printer for replenishing ink in an ink tank. JP-A-2023-43905 discloses an ink replenishment container used for replenishing ink in an ink tank of an ink replenishment type.

In the technique in JP-A-2023-43905, the ink replenishment container has a valve using a spring member inside an ink outlet forming portion. In a closed state of the valve, the spring member biases a valve body toward a seal member, and the valve body comes into contact with the seal member, whereby an ink flow through a gap between the valve body and the seal member is blocked. On the other hand, in a case where the ink replenishment container is attached to a printer, an ink introduction member of the printer presses the valve body in a direction opposite to a biasing direction of the spring, and the valve body separates from the seal member. Accordingly, the ink flow through the gap between the valve body and the seal member is enabled, and the ink in the ink replenishment container is supplied to the printer.

In the technique in JP-A-2023-43905, a cap has a projection. When the cap is completely closed, the projection presses the valve body in a direction away from the seal member to maintain an open state of the valve. In a detachment process of the cap, the inside of the ink replenishment container communicates with the outside of the ink replenishment container. Here, the pressure in the ink replenishment container may rise due to a change in temperature or a change in pressure. In this case, in the detachment process of the cap, air flows out from the inside of the ink replenishment container to the outside, and a pressurized state in the ink replenishment container is eliminated. When the detachment process of the cap further progresses, the projection of the cap is separated from the valve body, and the valve body comes into contact with the seal member, whereby the valve is brought into the closed state.

In the related art, in a case where the detachment operation of the cap is performed in an upright position of the ink replenishment container in which the ink outlet is oriented upward, the air in the ink replenishment container flows out to the outside, and the pressurized state can be eliminated. However, when the detachment operation of the cap is performed in a position different from the upright position, such as a state in which the ink outlet is horizontally oriented, a state in which the ink outlet is inclined downward, or a state in which the ink outlet is oriented directly downward, even when the inside of the ink replenishment container is not in the pressurized state, water head pressure is applied, and thus the ink may leak into the cap via the valve in the open state. In a case where the ink leaks into the cap, there may be a problem in that ink contamination occurs, for example, a hand of a user who performs the detachment operation of the cap may be contaminated with the ink, or the ink may drip onto the periphery and the periphery may be contaminated with the ink.

### SUMMARY

According to an aspect of the present disclosure, there is provided an ink replenishment container for replenishing ink in a printer. This ink replenishment container includes an ink accommodating portion configured to accommodate ink; an ink outlet forming portion having an outlet opening on a front end side opposite an ink accommodating portion side; a valve disposed in the ink outlet forming portion including the outlet opening and configured to bring an internal flow path through which the ink accommodating portion communicates with the outlet opening into either a fluid communication state or a fluid non-communication state; and a cap configured to take a sealed state in which the cap is attached to the ink outlet forming portion and the outlet opening is sealed and an unsealed state in which the sealing of the outlet opening is released, wherein the valve includes a seal member disposed on the front end side, a valve body configured and arranged to come into contact with and to be separated from the seal member, and a spring member configured to bias the valve body in a first direction toward the seal member, wherein the valve is brought into a closed state by bringing the valve body into contact with the seal member by the spring member, thereby bringing the internal flow path into the fluid non-communication state, wherein the cap includes a projection configured to press the valve body in a second direction opposite to the first direction in the sealed state, the projection having a projection end portion facing the valve body in the sealed state, wherein, at least in the sealed state, the valve is brought into an open state by the valve body being pressed in the second direction by the projection and being separated from the seal member, thereby bringing the internal flow path into the fluid communication state, wherein in a detachment process of detaching the cap from the ink outlet forming portion, in the unsealed state, the projection end portion takes a valve-closed position at which the valve is in the closed state, the valve-closed position being a position with respect to the ink outlet forming portion in an axial direction along the first direction, and wherein the cap includes a snap-fit portion configured to be locked to the ink outlet forming portion by a snap-fit in the sealed state.

### BRIEF DESCRIPTION OF THE DRAWINGS

FIG. 1 is a perspective view of a printer according to a first embodiment.

FIG. 2 is a perspective view illustrating a state in which ink is replenished in an ink tank.

FIG. 3 is an exploded perspective view of an ink replenishment container according to the first embodiment.

FIG. 4 is a first perspective view of a valve.

FIG. 5 is a second perspective view of the valve.

FIG. 6 is a perspective view of the ink tank of the embodiment.

FIG. 7 is a sectional view illustrating an ink replenishment state in which ink is replenished in the ink tank.

FIG. 8 is a front view of the ink replenishment container in an upright position.

FIG. 9 is a plan view of the ink replenishment container.

FIG. 10 is a partial longitudinal sectional view of the ink replenishment container.

FIG. 11 is a partial longitudinal sectional view of the ink replenishment container.

FIG. 12 is a first schematic view for explaining an ink replenishment container of a second embodiment.

FIG. 13 is a second schematic view for explaining the ink replenishment container of the second embodiment.

### DESCRIPTION OF EMBODIMENTS

### A. First Embodiment

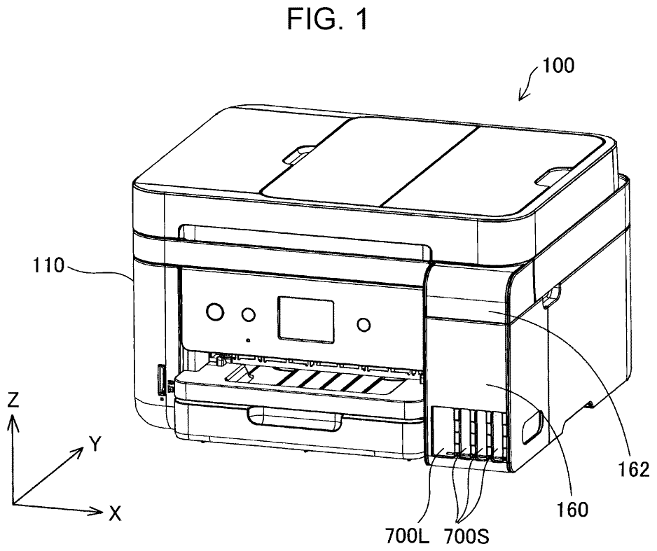

FIG. 1 is a perspective view of a printer 100 according to a first embodiment. The printer 100 is an ink jet printer that performs printing by ejecting ink onto a print medium. In FIG. 1, X-, Y-, and Z-axes orthogonal to each other are illustrated. The X-axis corresponds to a width direction of the printer 100, the Y-axis corresponds to a front/rear direction of the printer 100, and the Z-axis corresponds to a height direction of the printer 100. The printer 100 is installed on a horizontal installation surface defined by an X direction and a Y direction. Note that the “X direction” is a direction along the X-axis and means a concept including both a +X direction and a −X direction. Similarly, the “Y direction” is a direction along the Y-axis and means a concept including both a +Y direction and a −Y direction, and a “Z direction” is a direction along the Z-axis and is an up-down direction. That is, the “Z direction” means a concept including both a +Z direction which is a vertically upward direction and a −Z direction which is a vertically downward direction.

The printer 100 includes a housing 110. A carriage (not illustrated) that is movable in a main scanning direction, which is the X direction, is provided inside the housing 110. A print head that ejects ink onto a print medium is installed in the carriage. An ink tank accommodating unit 160 that accommodates a plurality of ink tanks 700S and 700L is provided at one end of a front surface of the housing 110. The ink tank accommodating unit 160 includes an openable/closable lid 162 at an upper portion thereof. The ink tanks 700S are small-capacity tanks, and the ink tank 700L is a large-capacity tank. In the following description, both ink tanks 700S and 700L will be simply referred to as “ink tank 700” without distinction. Each ink tank 700 is connected to the print head of the carriage by a tube (not illustrated). That is, the ink tanks 700 are stationary ink tanks that are not mounted on the carriage of the printer 100. Further, each ink tank 700 is an ink replenishment-type ink tank in which ink is replenished from an ink replenishment container when the remaining ink level is low. Although the ink tanks 700 are stationary ink tanks in the present embodiment, the ink tanks 700 may be mounted on the carriage of the printer 100.

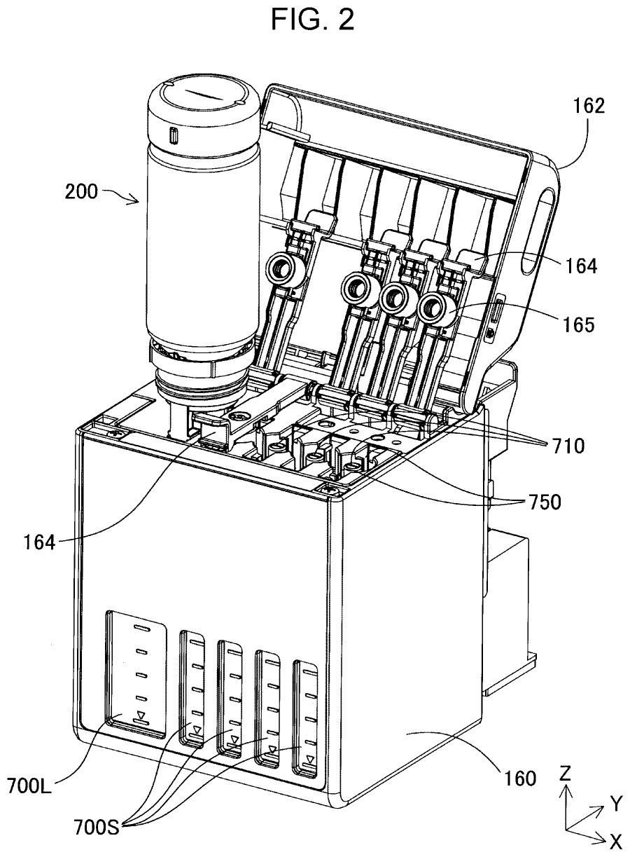

FIG. 2 is a perspective view illustrating a state in which ink is replenished in the ink tank 700 by using an ink replenishment container 200. A front surface of each ink tank 700 is formed of a transparent material so that the remaining ink level of the ink tank 700 can be seen from the outside. When the remaining ink level is low, as illustrated in FIG. 2, the ink can be replenished from an ink introduction member 710 having a flow path communicating with the ink tank 700 by opening the lid 162. The ink introduction member 710 is a tubular member extending in the Z direction, which is the up-down direction.

The tubular ink introduction member 710 is provided on an upper surface of each ink tank 700 in order to replenish ink in the ink tank 700. The ink tank accommodating unit 160 includes a sealing cap member 164 having a sealing cap 165 for sealing a front end of the ink introduction member 710. In a state in which ink is not replenished in the ink tank 700, the front end of the ink introduction member 710 is sealed by the sealing cap 165 of the sealing cap member 164. When the ink is replenished in the ink tank 700, the sealing cap member 164 is removed from the ink introduction member 710, and the ink replenishment container 200 is inserted at the position of the ink introduction member 710 to replenish the ink. Two inlet forming portions 750 that are fitted to protruding portions of the ink replenishment container 200, which will be described later, are provided around the ink introduction member 710. The two inlet forming portions 750 have a shape with 180-degree rotational symmetry about the ink introduction member 710.

In the present specification, the term “ink replenishment” means an operation of supplying ink to the ink tank 700 to increase the remaining ink level. However, the ink tank 700 does not need to be completely filled with the ink through the “ink replenishment”. In addition, the “ink replenishment” also means an operation of filling an empty ink tank 700 with the ink when the printer 100 is used for the first time. As described above, the ink replenishment container 200 replenishes the ink in the ink tank 700 via the ink introduction member 710 having a flow path communicating with the ink tank 700.

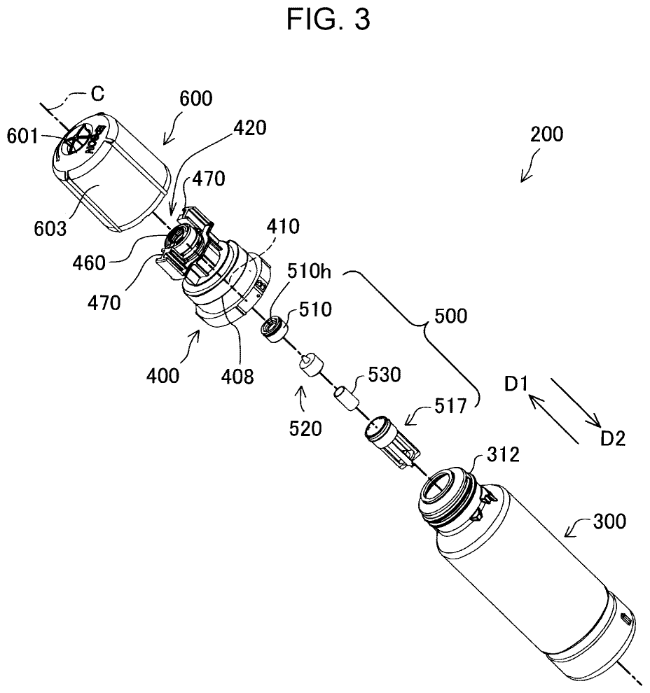

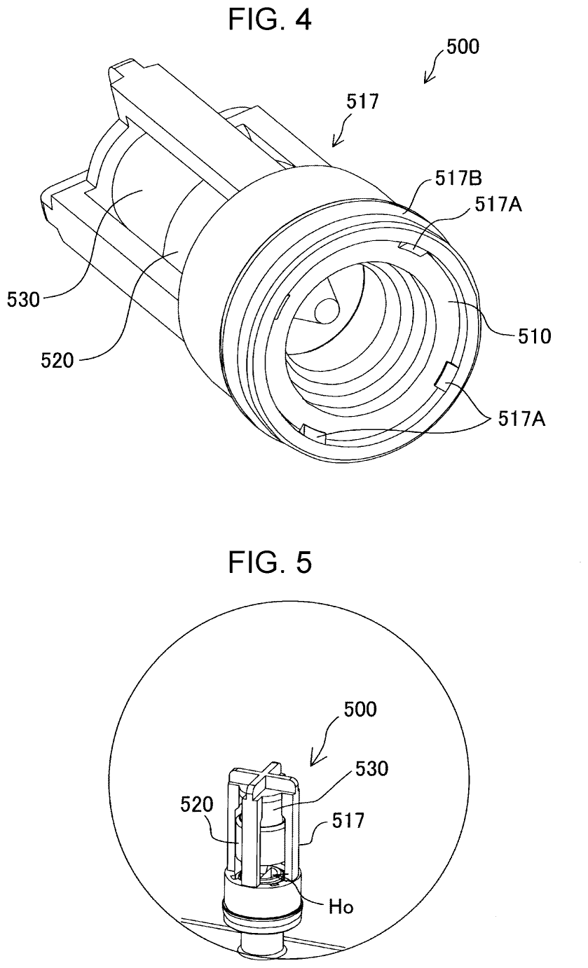

FIG. 3 is an exploded perspective view of the ink replenishment container 200 according to the first embodiment. FIG. 4 is a first perspective view of a valve 500. FIG. 5 is a second perspective view of the valve 500. As illustrated in FIG. 3, the ink replenishment container 200 includes an ink accommodating portion 300, an ink outlet forming portion 400, the valve 500, and a cap 600.

The ink accommodating portion 300 is configured to be able to accommodate ink. The ink outlet forming portion 400 is connected to the ink accommodating portion 300. The ink outlet forming portion 400 forms an outlet opening 460 for the ink on a side opposite the ink accommodating portion 300 side. The outlet opening 460 is formed in a cylindrical shape so that the ink introduction member 710 is inserted therein. The ink outlet forming portion 400 including the outlet opening 460 has the same central axis C as the ink replenishment container 200.

The valve 500 is disposed inside the ink outlet forming portion 400. The valve 500 is brought into an open state when the ink introduction member 710 is inserted from the outlet opening 460, and is brought into a closed state when the ink introduction member 710 is removed from the outlet opening 460. The cap 600 is configured to be attachable to and detachable from the ink outlet forming portion 400.

An upper end side which is the cap 600 side of the ink replenishment container 200 is referred to as a “front end side”, and a lower end side which is the ink accommodating portion 300 side is referred to as a “rear end side”. The ink accommodating portion 300 is a hollow cylindrical container having an opening on the front end side. An external thread 312 for attaching the ink outlet forming portion 400 is provided in a small-diameter portion at a front end of the ink accommodating portion 300. In the present disclosure, a direction along the central axis C of the ink replenishment container 200, that is, a direction parallel to the central axis C, is referred to as an “axial direction”, and a direction orthogonal to the axial direction is referred to as a “radial direction”. The direction from the rear end side of the ink accommodating portion 300 toward the outlet opening 460 located on the front end side in the axial direction is also referred to as a first direction D1. Further, a direction opposite to the first direction D1 is referred to as a second direction D2.

The ink outlet forming portion 400 has the outlet opening 460 for allowing the ink to flow out on the front end side opposite the ink accommodating portion 300 side. The ink outlet forming portion 400 is connected to the ink accommodating portion 300, and includes a tubular portion 420 having the outlet opening 460. The valve 500 is attached to the tubular portion 420. Therefore, the valve 500 can be regarded as a member forming a part of the ink outlet forming portion 400. The ink outlet forming portion 400 includes an internal flow path 410 through which the ink accommodating portion 300 is in fluid communication with the outlet opening 460 in the tubular portion 420. The internal flow path 410 is defined by disposing the valve 500 in the ink outlet forming portion 400. When ink is replenished in the ink tank 700, the ink introduction member 710 illustrated in FIG. 2 of the ink tank 700 is inserted into the outlet opening 460.

The valve 500 is disposed in the ink outlet forming portion 400 including the outlet opening 460. The valve 500 switches between opening and closing of the internal flow path 410 through which the ink accommodating portion 300 communicates with the outlet opening 460. That is, the valve 500 controls the internal flow path 410 to be in either a fluid communication state or a fluid non-communication state. The fluid communication state is a state in which fluid can flow between the ink accommodating portion 300 and the outlet opening 460. The fluid non-communication state is a state in which the internal flow path 410 is blocked and the fluid cannot flow between the ink accommodating portion 300 and the outlet opening 460.

As illustrated in FIG. 3, the valve 500 includes a valve housing 517, a spring member 530, a valve body 520, and a seal member 510. The ink introduction member 710 can be inserted into and removed from the valve housing 517. The valve housing 517 extends in the axial direction. The valve housing 517 is attached inside the tubular portion 420 so as to provide a gap in the radial direction between the valve housing 517 and the tubular portion 420. The valve housing 517 houses the spring member 530, the valve body 520, and the seal member 510 therein. As illustrated in FIG. 4, the valve housing 517 has retaining portions 517A on the front end side for suppressing the seal member 510 from coming off from the valve housing 517 and an engaging portion 517B for engaging with the tubular portion 420. Therefore, since the valve 500 alone is attachable and detachable as an element of the ink replenishment container 200, manufacturing is easy.

The spring member 530 illustrated in FIG. 3 is supported by the valve housing 517 in the valve housing 517. The spring member 530 is housed on the rear end side, which is the second direction D2 side in the axial direction, in the valve housing 517. The spring member 530 can be formed of, for example, metal. In the present embodiment, the spring member 530 is a coil spring. The spring member 530 biases the valve body 520 in the first direction D1 toward the seal member 510.

The seal member 510 is disposed on the front end side in the ink outlet forming portion 400. The seal member 510 is supported by the valve housing 517 inside the valve housing 517. The seal member 510 is formed of an elastic material. The seal member 510 is formed of, for example, a rubber material such as an elastomer having rubber elasticity. The elements of the ink replenishment container 200 other than the spring member 530 and the seal member 510 can be formed of, for example, a synthetic resin such as polyethylene or polypropylene. The seal member 510 is located closer to the outlet opening 460 than the valve body 520 and the spring member 530 in the axial direction. The seal member 510 has an annular shape. A through hole 510h extending in the axial direction is formed in the seal member 510. The ink introduction member 710 is inserted into and removed from the through hole 510h in the axial direction. The through hole 510h forms a part of the internal flow path 410.

The valve body 520 faces the seal member 510 in the axial direction. The valve body 520 is disposed in the valve housing 517 so as to be able to come into contact with and separate from the seal member 510. That is, the valve body 520 is configured to be movable in the axial direction in the valve housing 517. The valve body 520 is located closer to the outlet opening 460 than the spring member 530 in the axial direction. The valve body 520 is biased toward the first direction D1 by the spring member 530. When the valve body 520 comes into contact with the seal member 510 so as to cover the through hole 510h, the valve 500 is brought into the closed state. That is, the valve 500 is brought into the closed state by bringing the valve body 520 into contact with the seal member 510 by the spring member 530, thereby bringing the internal flow path 410 into the fluid non-communication state. On the other hand, when the valve body 520 is separated from the seal member 510, the valve 500 is brought into the open state.

As illustrated in FIG. 5, the valve housing 517 has a total of four through-holes Ho extending therethrough in the radial direction. The through-holes Ho communicate with a gap in the radial direction between the valve housing 517 and the valve body 520. The through-holes Ho are formed so as to extend also in the axial direction. The through-holes Ho form a part of the internal flow path 410. In the open state of the valve, a flow path formed inside the ink introduction member 710, which will be described later, and the through-holes Ho communicate with each other, whereby gas-liquid exchange is performed between the ink introduction member 710 and the ink replenishment container 200. Accordingly, ink is replenished in the ink tank 700 from the ink replenishment container 200.

The cap 600 illustrated in FIG. 3 is detachably attached to the ink outlet forming portion 400. In the present embodiment, the cap 600 is attached to and detached from the ink outlet forming portion 400 by a snap-fit engagement. A specific configuration of the snap-fit will be described later.

The cap 600 selectively takes two states: a sealed state in which the cap 600 is attached to the ink outlet forming portion 400 and the outlet opening 460 is sealed; and an unsealed state in which the sealing of the outlet opening 460 is released. The cap 600 has a top wall 601 facing the outlet opening 460 in the axial direction, and a tubular side wall 603 having the central axis C. The top wall 601 is located at an uppermost portion of the cap 600 in an upright position of the ink replenishment container 200. Further details of the cap 600 will be described later.

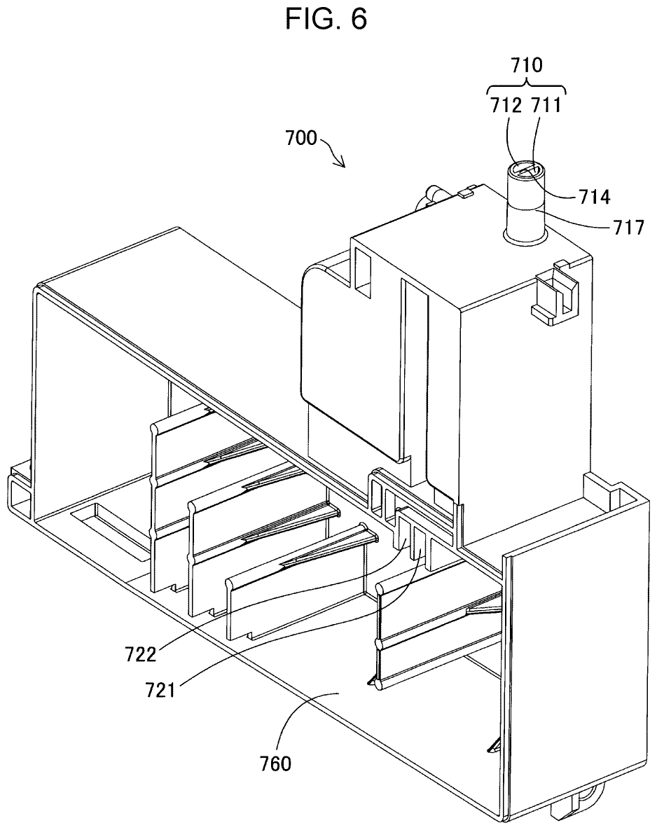

A configuration of the ink tank 700 will be described before the ink replenishment container 200 is further described in detail. FIG. 6 is a perspective view of the ink tank 700 according to the first embodiment. The ink introduction member 710 of the ink tank 700 protrudes upward from the ink tank 700. The ink introduction member 710 has a side surface 717.

The ink introduction member 710 has two flow paths 711 and 712. The two flow paths 711 and 712 are partitioned by a partition wall 714. When ink is replenished, one of the flow paths 711 and 712 forms a flow path for ink from the ink replenishment container 200, and the other forms a flow path for air from the ink tank 700 to the ink replenishment container 200. The number of the flow paths 711 and 712 included in the ink introduction member 710 is not limited to two, and may be three or more as long as there are a plurality of flow paths.

The front end of the ink introduction member 710 is flat, and the two flow paths 711 and 712 are open at the front end of the ink introduction member 710. In addition, a part of the front end of the ink introduction member 710 corresponds to an end portion of the partition wall 714. The two flow paths 711 and 712 communicate with two in-tank flow paths 721 and 722, respectively, protruding into an ink accommodating chamber 760 below. Lower ends of the in-tank flow paths 721 and 722 extend downward beyond the ceiling of the ink accommodating chamber 760. This is because when the ink is replenished in the ink tank 700 from the ink replenishment container 200, the gas-liquid exchange stops when the liquid level in the ink accommodating chamber 760 reaches the lower ends of the in-tank flow paths 721 and 722 and the replenishment of the ink also stops accordingly, making the ink replenishment operation easy.

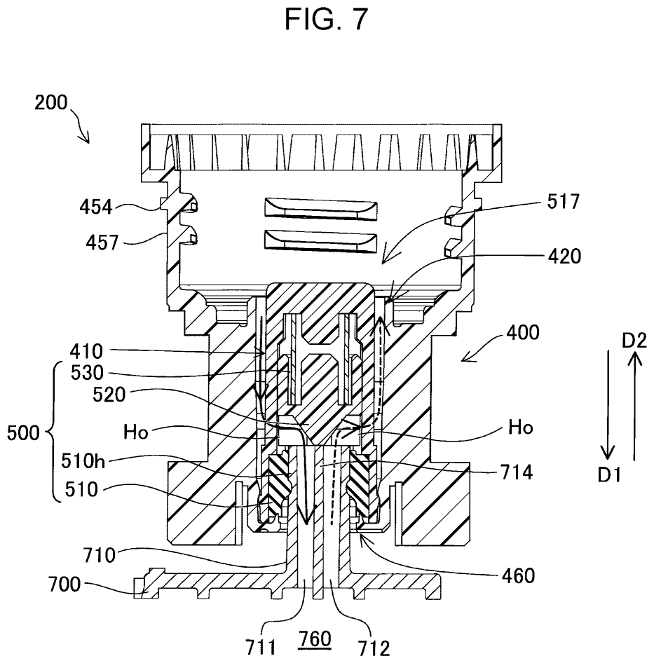

FIG. 7 is a sectional view illustrating a replenishment state in which ink is replenished in the ink tank 700 from the ink replenishment container 200. In this replenishment state, the ink replenishment container 200 takes an inverted position opposite to the upright position. The ink introduction member 710 of the ink tank 700 is inserted into the internal flow path 410 in the ink outlet forming portion 400 via the through hole 510h of the seal member 510. As a result, the valve body 520 is displaced by the ink introduction member 710 in the second direction D2, which is a direction away from the seal member 510, so that the valve body 520 is separated from the seal member 510. Thus, the valve 500 is brought into the open state. The ink in the ink accommodating portion 300 is supplied to the ink introduction member 710 via the internal flow path 410 formed by a gap between an inner peripheral surface of the tubular portion 420 and the valve housing 517, and the like, and air flows into the ink accommodating portion 300 from the ink accommodating chamber 760. As a result, the gas-liquid exchange is performed, and the ink is replenished in the ink tank 700. In FIG. 7, the arrow indicated by the solid line schematically indicates the flow of ink, and the arrow indicated by the dashed line schematically indicates the flow of air.

When the replenishment of ink in the ink tank 700 is completed and the ink replenishment container 200 is removed from the ink introduction member 710, the valve body 520 is brought into contact with the seal member 510 by a biasing force of the spring member 530. As a result, the through hole 510h of the seal member 510 is closed by the valve body 520, so that the valve 500 is brought into the closed state. When the valve 500 is in the closed state, the leakage of the ink in the ink replenishment container 200 to the outside can be suppressed. When the ink is replenished in the ink tank 700 from the ink replenishment container 200, it is not necessary to squeeze the ink accommodating portion 300. The type of ink replenishment container capable of replenishing the ink without squeezing the ink accommodating portion 300 as described above is also referred to as a “non-squeeze type”.

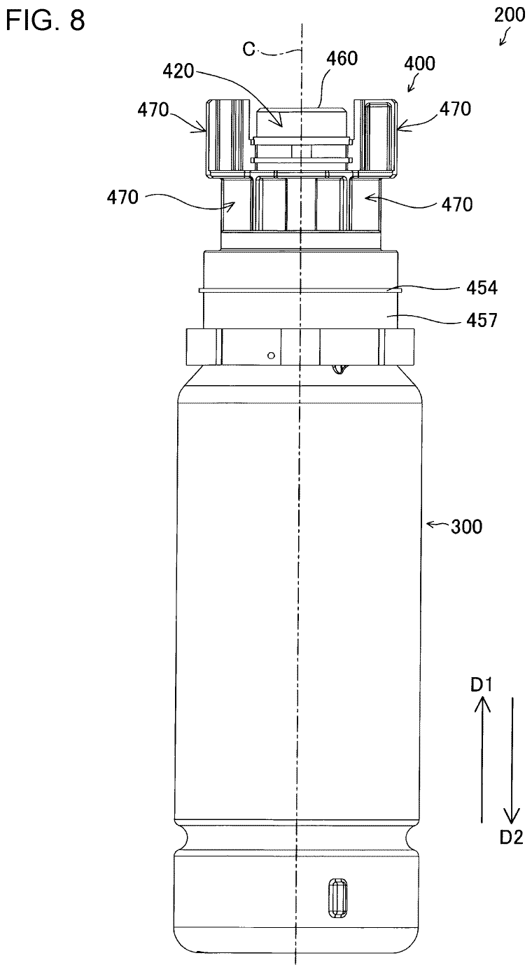

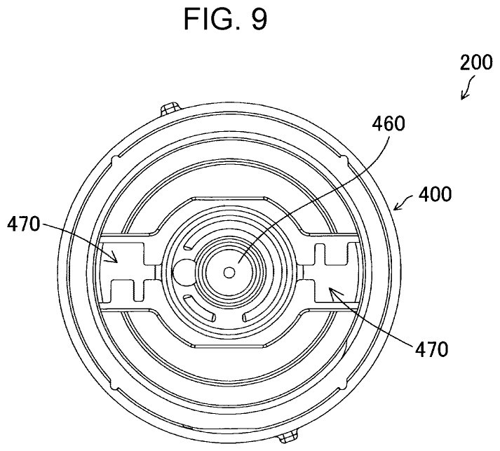

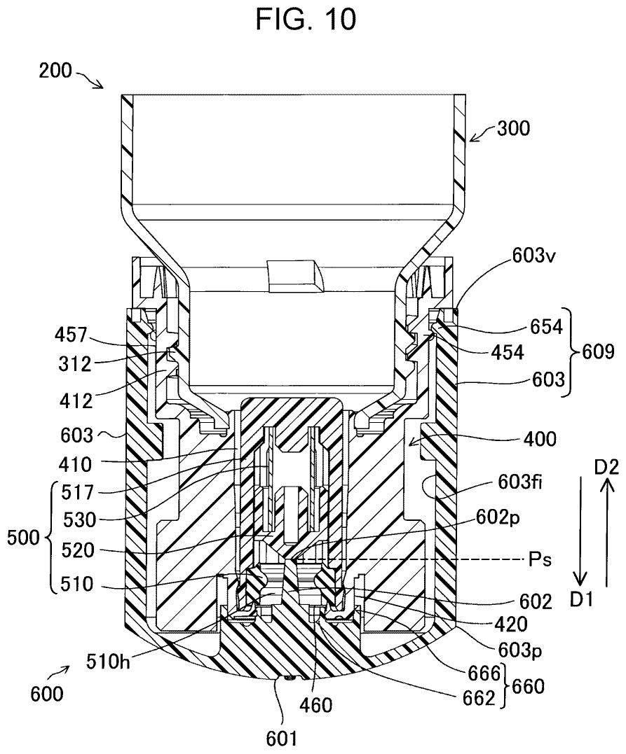

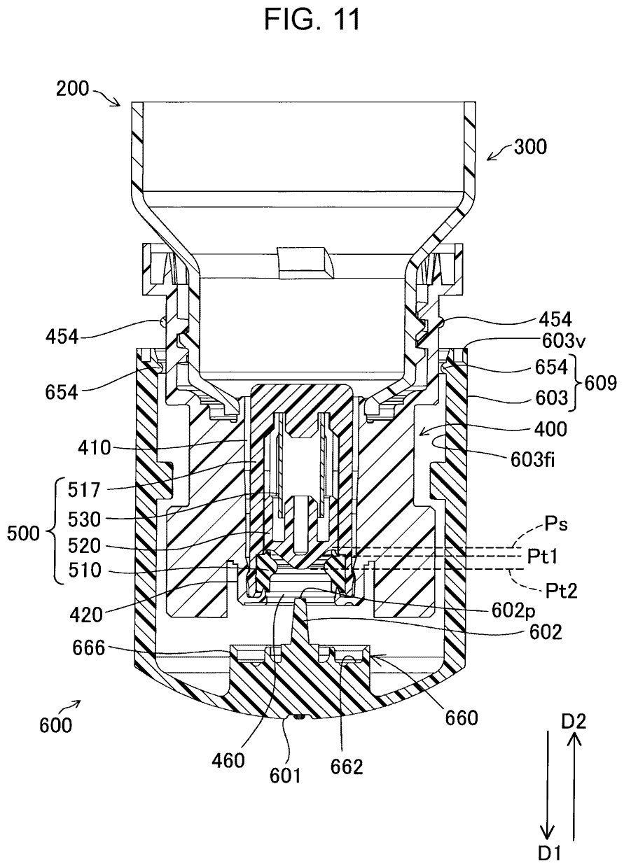

The detailed structure of the ink replenishment container 200 will be described with reference to FIG. 8 and the subsequent drawings. FIG. 8 is a front view of the ink replenishment container 200 in the upright position. FIG. 9 is a plan view of the ink replenishment container 200. FIGS. 10 and 11 are partial longitudinal sectional views of the ink replenishment container 200. The ink replenishment container 200 illustrated in FIGS. 8 and 9 is in a state in which the cap 600 is detached. FIG. 10 is a partial sectional view illustrating the sealed state in which the cap 600 is attached to the ink outlet forming portion 400 and the outlet opening 460 is sealed. FIG. 11 is a partial sectional view illustrating the unsealed state in which the engagement between the cap 600 and the ink outlet forming portion 400 is released and the sealing of the outlet opening 460 is released. The “upright position of the ink replenishment container 200” refers to a position of the ink replenishment container 200 in which the outlet opening 460 faces upward, and in which the ink replenishment container 200 is placed on a horizontal surface such as a desk with a bottom portion of the ink accommodating portion 300 facing downward.

As illustrated in FIG. 8, the ink outlet forming portion 400 of the ink replenishment container 200 includes protruding portions 470 as container side identification members and a base end portion 457 in which a locked portion 454 is formed, in addition to the outlet opening 460 and the tubular portion 420.

The protruding portions 470 are disposed on both sides of the tubular portion 420 in a direction intersecting the central axis C. The pair of the protruding portions 470 are substantially rectangular parallelepiped members protruding radially outward from an outer peripheral surface of the tubular portion 420. The protruding portions 470 project axially upward from the base end portion 457 side, and extend so as to have a constant dimension in the axial direction.

Each of the two protruding portions 470 has an identification shape corresponding to the shape of the inlet forming portions 750 of the ink tank accommodating unit 160. In each of the ink inlet forming portions 750, an identification pattern is formed by a combination of ribs and grooves extending in a depth direction. On the other hand, an identification pattern composed of a combination of ribs and grooves extending in the axial direction is formed on a side surface of each of the protruding portions 470. FIG. 9 is a plan view of the ink replenishment container 200 as viewed in the axial direction from the outlet opening 460, and illustrates an example of the identification patterns of the protruding portions 470. The identification patterns are provided in 180-degree rotational symmetry about the outlet opening 460. The identification shape of the protruding portions 470 varies depending on the type of ink accommodated in the ink replenishment container 200. That is, the protruding portions 470 have an identification shape for identifying the type of ink accommodated in the ink accommodating portion 300. In a case where an incorrect type of the ink replenishment container 200 is about to be attached to the ink introduction member 710, the protruding portions 470 and the inlet forming portions 750 interfere with each other, and the ink introduction member 710 cannot be attached to the ink replenishment container 200. On the other hand, in a case where a correct type of the ink replenishment container 200 is about to be attached to the ink introduction member 710, the protruding portions 470 and the inlet forming portions 750 do not interfere with each other. Thus, the ink is prevented from being erroneously poured into the ink tank 700.

As illustrated in FIG. 8, the base end portion 457 is a tubular member located farther in the second direction D2 than the tubular portion 420 having the outlet opening 460 and the protruding portion 470. The base end portion 457 is connected to an end portion of the tubular portion 420 in the second direction D2. On an outer peripheral surface of the base end portion 457, a locked portion 454 to be locked to a locking portion of a snap-fit portion of the cap 600 described later is formed. The locked portion 454 is a projection protruding from the outer peripheral surface of the base end portion 457. In the present embodiment, the locked portion 454 is continuously formed over the entire perimeter of the outer peripheral surface of the base end portion 457. In other embodiments, the locked portion 454 does not need to be continuously formed in a circumferential direction of the base end portion 457, and may be intermittently formed or may be formed only in part in the circumferential direction. As shown in FIG. 10, a thread 412 to be screwed with the external thread 312 of the ink accommodating portion 300 shown in FIG. 3 is formed on an inner peripheral surface of the base end portion 457.

As shown in FIG. 10, the cap 600 further includes a projection 602, a sealing portion 660, and a snap-fit portion 609. The sealing portion 660 seals the outlet opening 460 by engaging with the tubular portion 420 defining the outlet opening 460. The sealing portion 660 is a wall portion that is formed inside the cap 600 and faces the outlet opening 460. The sealing portion 660 is a recessed portion having a bottom wall 662 in the first direction D1, and has a side wall 666. The side wall 666 extends upward in the second direction D2 from a peripheral portion of the bottom wall 662. In an attached state of the cap 600, the sealing portion 660 seals the outlet opening 460 with the side wall 666 in contact with the outer peripheral surface of the tubular portion 420 in the circumferential direction. The method of sealing the outlet opening 460 by the sealing portion 660 is not limited to the present embodiment, and it is only required that the outlet opening 460 can be sealed by the sealing portion 660. For example, in other embodiments, the outlet opening 460 may be sealed by bringing the sealing portion 660 into contact with the inner peripheral surface of the tubular portion 420, or the outlet opening 460 may be sealed by bringing the sealing portion 660 into contact with a front end surface of the tubular portion 420 forming the outlet opening 460.

The projection 602 extends toward the valve body 520 in the second direction D2 from a central portion of an inner surface of the top wall 601. The projection 602 has a projection end portion 602p facing the valve body 520. In the sealed state of the cap 600 illustrated in FIG. 10, the projection 602 presses the valve body 520 in the second direction D2 to separate the valve body 520 from the seal member 510, thereby bringing the valve 500 into the open state. That is, in the sealed state, the projection 602 brings the internal flow path 410 into the fluid communication state.

The snap-fit portion 609 is locked to the locked portion 454 of the ink outlet forming portion 400 by a snap-fit in the sealed state of the outlet opening 460 by the cap 600. The snap-fit portion 609 has the side wall 603 and a locking portion 654 formed on an inner peripheral surface 603fi of the side wall 603. The side wall 603 has a first end portion 603p which is an end portion in the first direction D1, and a second end portion 603v which is an end portion in the second direction D2. The first end portion 603p is connected to a peripheral portion of the top wall 601. The second end portion 603v defines an opening of the cap 600. The second end portion 603v side of the side wall 603 is elastically deformable in the radial direction about the first end portion 603p. Specifically, when the cap 600 is attached to or detached from the ink outlet forming portion 400, the second end portion 603v side of the side wall 603 is elastically deformed so as to expand radially outward by a protrusion length of the locked portion 454 in the radial direction.

The locking portion 654 is a projection continuously formed over the entire perimeter of the inner peripheral surface 603fi. The locking portion 654 is disposed in the vicinity of the second end portion 603v. The locking portion 654 has a locking surface to be locked to the locked portion 454. In the sealed state of the outlet opening 460, the locking portion 654 of the snap-fit portion 609 is locked to the locked portion 454 of the ink outlet forming portion 400. Accordingly, in a case where a force F that relatively displaces the cap 600 with respect to the ink outlet forming portion 400 in the second direction D2 is less than a predetermined value, the locking between the locking portion 654 and the locked portion 454 along the axial direction is maintained and the attached state of the cap 600 to the ink outlet forming portion 400 is maintained. On the other hand, in a case where the force F exceeds the predetermined value, the side wall 666 is elastically deformed such that the second end portion 603v climbs over the locked portion 454, the locking between the locking portion 654 and the locked portion 454 is released, and the cap 600 can be detached from the ink outlet forming portion 400.

As described above, in the sealed state of the outlet opening 460 by the cap 600, the snap-fit portion 609 is locked to the ink outlet forming portion 400 by a snap-fit. In addition, at least in the sealed state of the cap 600, the valve 500 is brought into the open state by the valve body 520 being pressed by the projection end portion 602p of the projection 602 and being separated from the seal member 510, thereby bringing the internal flow path 410 into the fluid communication state.

In a case where the force F exceeding the predetermined value is applied by a detachment operation of the cap 600 from the sealed state of the cap 600 illustrated in FIG. 10, the locking between the snap-fit portion 609 of the cap 600 and the locked portion 454 of the ink outlet forming portion 400 is released.

As illustrated in FIG. 11, in a detachment process of detaching the cap 600 from the ink outlet forming portion 400, the relative position of the cap 600 with respect to the ink outlet forming portion 400 changes. In detail, the cap 600 is displaced in the first direction D1 by the detachment operation of the cap 600 by a user. In accordance with the position of the cap 600 in the first direction D1, the valve 500 is in either the open state or the closed state, and the cap 600 is in either the sealed state or the unsealed state. This will be described in detail below.

First, as illustrated in FIG. 10, in the attached state of the cap 600 in which the locking portion 654 is locked to the locked portion 454, the cap 600 is in the sealed state in which the outlet opening 460 is sealed, and the valve 500 is in the open state. In the attached state of the cap 600, the relative position of the projection end portion 602p with respect to the ink outlet forming portion 400 in the axial direction is a reference position Ps. In the present embodiment, the reference position Ps is a position slightly farther in the second direction D2 than the seal member 510.

In a case where the cap 600 moves from the position of the attached state in the first direction D1 after the detachment operation by the user is further performed and the locking between the locking portion 654 and the locked portion 454 is released, the projection end portion 602p takes a first position Pt1 as a valve-open position which is a relative position with respect to the ink outlet forming portion 400. As illustrated in FIG. 11, the first position Pt1 as the valve-open position is located farther in the first direction D1 than the reference position Ps illustrated in FIG. 10 in the axial direction. The first position Pt1 is located farther in the second direction D2 in the axial direction than a second position Pt2 to be described later. When the projection end portion 602p takes the first position Pt1, the cap 600 is switched from the sealed state to the unsealed state. At the first position Pt1 of the projection end portion 602p, the valve body 520 is pressed by the projection end portion 602p and is located farther in the second direction D2 than in the closed state. Therefore, the seal member 510 and the valve body 520 are separated from each other, and the valve 500 is in the open state.

In a case where the detachment operation by the user progresses further than when the projection end portion 602p is at the first position Pt1, the cap 600 moves further toward the first direction D1. As a result, the projection end portion 602p takes the second position Pt2 as a valve-closed position which is a relative position with respect to the ink outlet forming portion 400. The second position Pt2 as the valve-closed position is located farther in the first direction D1 in the axial direction than the first position Pt1. When the projection end portion 602p takes the second position Pt2, the valve body 520 is in contact with the seal member 510 so that the valve 500 is in the closed state. Further, when the projection end portion 602p takes the second position Pt2, the cap 600 is in the unsealed state.

That is, in the process of the detachment operation of the cap 600, the valve 500 is in the open state and the cap 600 is in the unsealed state for a specific period of time during which the projection end portion 602p moves from the first position Pt1 to the second position Pt2. Therefore, in the attached state in which the cap 600 is attached to the ink outlet forming portion 400, even in a case where the pressure of the ink accommodating portion 300 increases due to a change in temperature or a change in pressure, the inside of the ink accommodating portion 300 communicates with the atmosphere outside the ink replenishment container 200 in the specific period in the detachment operation. Accordingly, in the specific period, the air in the ink replenishment container 200 including the ink accommodating portion 300 can be released to the outside, and thus a pressurized state of the ink accommodating portion 300 can be eliminated. In addition, even in a case where the ink accommodating portion 300 is not in the pressurized state, when the cap 600 is detached in a position in which the outlet opening 460 is directed sideways or downward, there is a possibility that the ink flows out toward the cap 600 due to water head pressure. Even in such a case, since the cap 600 is displaced in the first direction D1 in an extremely short time by being biased by the spring member 530 due to the release of the locking of the snap-fit portion 609, the projection end portion 602p reaches the second position Pt2, which is the valve-closed position, in a shorter time, and thus the valve 500 in the open state is instantaneously closed. Therefore, it is possible to suppress the amount of ink flowing out.

Here, in the case of an ink replenishment container in which a female thread portion is formed on the inner peripheral surface 603fi of the cap 600 and a male thread portion to be screwed into the female thread portion is formed on the base end portion 457 illustrated in FIG. 8, as in the related art, it is necessary to relatively rotate the cap about the axial direction with respect to the ink outlet forming portion in the detachment operation. Since the cap moves in the first direction D1 while rotating with respect to the ink outlet forming portion, the time required for the projection end portion 602p to reach the second position Pt2 from the reference position Ps and the time of the specific period are longer than those of the present embodiment.

On the other hand, in the present embodiment, since the cap 600 is locked to the ink outlet forming portion 400 by a snap-fit, it is possible to move the position of the projection end portion 602p from the reference position Ps to the second position Pt2 via the first position Pt1 in a shorter time in the detachment operation. Therefore, since the time of the open state of the valve 500 can be further shortened, it is possible to reduce the possibility that the ink in the ink accommodating portion 300 leaks to the outside.

According to the first embodiment, in a case where the detachment operation of detaching the cap 600 is performed, the projection end portion 602p can be moved from the reference position Ps to the second position Pt2 in a shorter time by the operation of releasing the locking by the snap-fit portion 609. Thus, even when the cap 600 is detached in a position different from the upright position, the time in which the valve 500 is in the open state and the specific period of a predetermined state in which the cap 600 is in the unsealed state and the valve 500 is in the open state in the detachment process can be shortened. Accordingly, for example, compared to a case where a thread-type cap is rotated and detached from the ink outlet forming portion, it is possible to shorten the time in which the valve 500 is in the open state and the time of the predetermined state, including the specific period, and thus it is possible to reduce the possibility that the ink leaks to the outside of the ink replenishment container 200. Therefore, it is possible to suppress the occurrence of ink contamination.

In addition, according to the first embodiment, since a predetermined space, which is the space between the ink outlet forming portion 400 and the cap 600, is enlarged in the process of releasing the locking of the snap-fit portion 609, the pressure in the predetermined space is lowered compared to the outside. That is, the predetermined space is defined as a closed space during a first period from an attached state of the cap 600 to the ink outlet forming portion 400 until the locking portion 654 climbs over the locked portion 454 and the locking portion 654 is separated from the locked portion 454. In the detachment process of the cap 600, in the first period, the cap 600 moves in a direction away from the ink outlet forming portion 400 while the predetermined space maintains a closed space. As a result, in the first period, the volume of the predetermined space increases, and the pressure of the predetermined space becomes lower than the atmospheric pressure. Accordingly, when the locking by the snap-fit portion 609 is released, the air is easily drawn into the predetermined space from the outside, and thus it is possible to further reduce the possibility that the ink leaks to the outside of the ink replenishment container 200. In the detachment process, in order to further reduce the pressure in the predetermined space, for example, the dimension of the locked portion 454, which is a projection, along the axial direction may be increased. For example, the dimension of the locked portion 454 along the axial direction may be set such that the pressure in the predetermined space is lower than the atmospheric pressure by a predetermined ratio in the detachment process.

### B. Second Embodiment

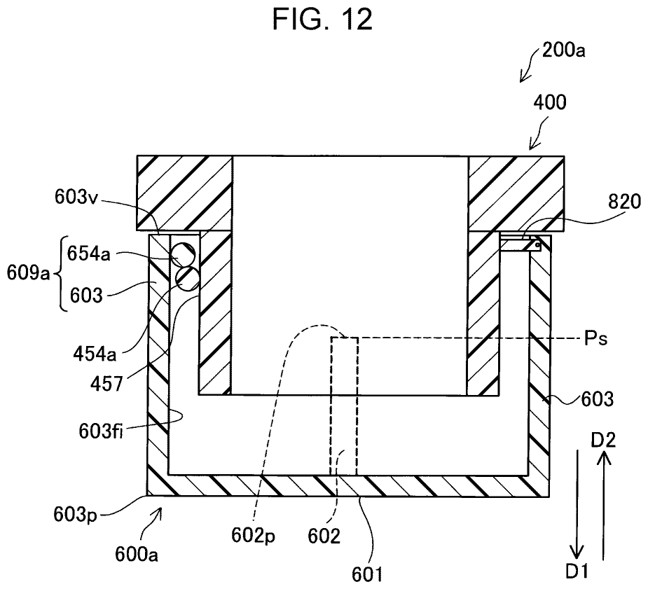

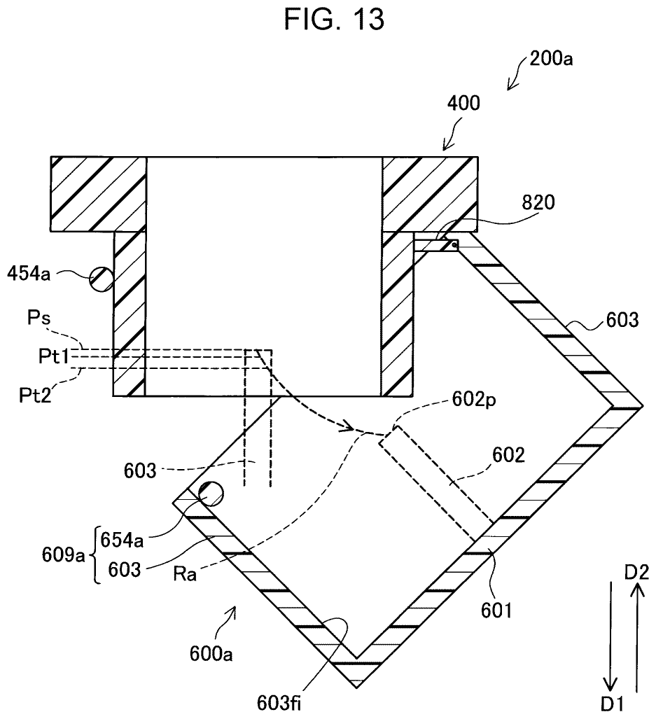

FIG. 12 is a first schematic view for explaining an ink replenishment container 200a of a second embodiment. FIG. 13 is a second schematic view for explaining the ink replenishment container 200a of the second embodiment. The ink replenishment container 200a of the second embodiment is different from the ink replenishment container 200 of the first embodiment illustrated in FIG. 10 in that a locking portion 654a of a snap-fit portion 609a is formed on a part of the entire perimeter of the inner peripheral surface 603fi, and a cap 600a is connected to the ink outlet forming portion 400 via a hinge 820. Since the other configurations of the ink replenishment container 200a are the same as those of the ink replenishment container 200 of the first embodiment, the same numerals are given to the same configurations, and the description thereof will be appropriately omitted. In addition, in FIGS. 12 and 13, elements similar to those of the first embodiment, such as the valve 500 and the sealing portion 660, are omitted as necessary.

In the ink replenishment container 200a illustrated in FIG. 12, the locking portion 654a is formed on the inner peripheral surface 603fi so as to have a first predetermined length in the circumferential direction. The first predetermined length is shorter than the entire perimeter of the inner peripheral surface 603fi and is long enough to be locked to a locked portion 454a.

The locked portion 454a is formed on the outer peripheral surface of the base end portion 457 so as to have a second predetermined length in the circumferential direction. The second predetermined length is shorter than the entire perimeter of the outer peripheral surface of the base end portion 457. The locked portion 454a is formed on the outer peripheral surface of the base end portion 457 at a position where it can be locked to the locking portion 654a.

The ink replenishment container 200a further includes the hinge 820. The hinge 820 is formed of, for example, a synthetic resin such as polyethylene or polypropylene. The cap 600a is connected to the ink outlet forming portion 400 via the hinge 820. In the attached state of the cap 600a, the hinge 820 is located on a side opposite the side where the locking portion 654a and the locked portion 454a are located in the radial direction.

As illustrated in FIG. 13, similarly to the first embodiment, in the detachment process of the cap 600a, the projection end portion 602p sequentially takes the reference position Ps, the first position Pt1, and the second position Pt2. The second embodiment is different from the first embodiment in that the projection end portion 602p moves in the first direction D1 in the detachment process in the first embodiment. On the other hand, in the second embodiment, the projection end portion 602p moves along a rotation locus Ra about the hinge 820.

The second embodiment has the same effects as the first embodiment in that the second embodiment has the same configuration as the first embodiment. For example, in a case where the detachment operation of detaching the cap 600a is performed, the projection end portion 602p can be moved from the reference position Ps to the second position Pt2 in a shorter time by an operation of releasing the locking by the snap-fit portion 609a. Accordingly, for example, compared to the case where a thread-type cap is rotated and detached from the ink outlet forming portion, it is possible to shorten the time in which the valve 500 is in the open state, and thus, it is possible to reduce the possibility that the ink leaks to the outside of the ink replenishment container 200a. Therefore, it is possible to suppress the occurrence of ink contamination. In addition, according to the second embodiment, it is possible to suppress the cap 600a from flying off and being lost due to the momentum for releasing the locking by the snap-fit portion 609a by the hinge 820. In addition, since it is possible to suppress the cap 600a from flying off, even in a case where ink has adhered to the cap 600a, it is possible to suppress the ink from being scattered to the periphery.

In the second embodiment, the locked portion 454a is formed in a part of the base end portion 457 in the circumferential direction, and the locking portion 654a is formed in a part of the inner peripheral surface 603fi in the circumferential direction. However, the present disclosure is not limited thereto. For example, as in the first embodiment, the locked portion 454a may be formed over the entire perimeter of the outer peripheral surface of the base end portion 457, and the locking portion 654a may be formed over the entire perimeter of the inner peripheral surface 603fi.

### C. Other Embodiments

### C-1. Another Embodiment 1

In each of the above-described embodiments, as illustrated in FIG. 3, the ink outlet forming portion 400 and the ink accommodating portion 300 are separated from each other, but may be integrated with each other.

### D. Other Aspects:

The present disclosure is not limited to the above-described embodiments, and can be realized in various aspects without departing from the gist of the present disclosure. For example, the present disclosure can also be implemented in the following aspects. The technical features in the above-described embodiments that correspond to the technical features in each of the embodiments described below can be replaced or combined as appropriate in order to solve a part or all of the problems of the present disclosure or to achieve a part or all of the effects of the present disclosure. In addition, when the technical features are not described as essential in the present specification, the technical features can be appropriately deleted.
(1) According to an aspect of the present disclosure, there is provided an ink replenishment container for replenishing ink in a printer. This ink replenishment container includes: an ink accommodating portion configured to accommodate ink; an ink outlet forming portion having an outlet opening on a front end side opposite an ink accommodating portion side; a valve disposed in the ink outlet forming portion including the outlet opening and configured to bring an internal flow path through which the ink accommodating portion communicates with the outlet opening into either a fluid communication state or a fluid non-communication state; and a cap configured to take a sealed state in which the cap is attached to the ink outlet forming portion and the outlet opening is sealed and an unsealed state in which the sealing of the outlet opening is released, wherein the valve includes a seal member disposed on the front end side, a valve body configured and arranged to come into contact with and to be separated from the seal member, and a spring member configured to bias the valve body in a first direction toward the seal member, wherein the valve is brought into a closed state by bringing the valve body into contact with the seal member by the spring member, thereby bringing the internal flow path into the fluid non-communication state, wherein the cap includes a projection configured to press the valve body in a second direction opposite to the first direction in the sealed state, the projection having a projection end portion facing the valve body in the sealed state, wherein, at least in the sealed state, the valve is brought into an open state by the valve body being pressed in the second direction by the projection and being separated from the seal member, thereby bringing the internal flow path into the fluid communication state, wherein in a detachment process of detaching the cap from the ink outlet forming portion, in the unsealed state, the projection end portion takes a valve-closed position at which the valve is in the closed state, the valve-closed position being a position with respect to the ink outlet forming portion in an axial direction along the first direction, and wherein the cap includes a snap-fit portion configured to be locked to the ink outlet forming portion by a snap-fit in the sealed state.

According to the above-described aspect, in a case where the detachment operation of detaching the cap is performed, it is possible to move the projection end portion to a second position in a shorter time by the operation of releasing the locking by the snap-fit portion. Thus, even when the cap is detached in a position different from the upright position, the time in which the valve is in the open state in the detachment process can be further shortened. Accordingly, for example, compared to the case where a thread-type cap is rotated and detached from the ink outlet forming portion, it is possible to shorten the time in which the valve is in the open state, and thus it is possible to reduce the possibility that the ink leaks to the outside of the ink replenishment container. Therefore, it is possible to suppress the occurrence of ink contamination.
(2) In the above-described aspect, the cap may be connected to the ink outlet forming portion via a hinge.

According to the above-described aspect, it is possible to suppress the cap from flying off and being lost due to the momentum for releasing the locking by the snap-fit portion. In addition, since it is possible to suppress the cap from flying off, even in a case where ink has adhered to the cap, it is possible to suppress the ink from being scattered to the periphery.
(3) In the above-described aspect, when the cap is switched from the sealed state to the unsealed state, the projection end portion may take a valve-open position at which the valve is in the open state, the valve-open position being a position with respect to the ink outlet forming portion in the axial direction, and the valve-open position may be located farther in the second direction than the valve-closed position in the axial direction.

According to this aspect, in a case where the detachment operation of detaching the cap is performed, it is possible to move the projection end portion from a first position to the second position in a shorter time by the operation of releasing the locking by the snap-fit portion. Accordingly, even when the cap is detached in a position different from the upright position, the time of the predetermined state in which the cap is in the unsealed state and the valve is in the open state in the detachment process can be further shortened. Therefore, since it is possible to reduce the possibility that the ink leaks out to the outside of the ink replenishment container, it is possible to further suppress the occurrence of ink contamination.
(4) In the above-described aspect, the cap may include a tubular side wall, the ink outlet forming portion may include a tubular base end portion located farther in the second direction than the outlet opening, the snap-fit portion may include a locking portion formed over an entire perimeter of an inner peripheral surface of the side wall, and the base end portion may include a locked portion formed over an entire perimeter of an outer peripheral surface of the base end portion and configured to be locked to the locking portion.

According to the above-described aspect, since the space between the ink outlet forming portion and the cap is enlarged in the process of releasing the locking of the snap-fit portion, the pressure in the space is lowered compared to the outside. Accordingly, when the locking by the snap-fit portion is released, the air is easily drawn into the space from the outside, and thus it is possible to further reduce the possibility that the ink leaks to the outside.

The present disclosure can also be implemented in various other forms. For example, the present disclosure can be implemented in a form such as a method for manufacturing an ink replenishment container.

What is claimed is:

1. An ink replenishment container for replenishing ink in a printer, the ink replenishment container comprising:
an ink accommodating portion configured to accommodate ink;
an ink outlet forming portion having an outlet opening on a front end side opposite an ink accommodating portion side;
a valve disposed in the ink outlet forming portion including the outlet opening and configured to bring an internal flow path through which the ink accommodating portion communicates with the outlet opening into either a fluid communication state or a fluid non-communication state; and
a cap configured to take a sealed state in which the cap is attached to the ink outlet forming portion and the outlet opening is sealed and an unsealed state in which the sealing of the outlet opening is released,
wherein the valve includes a seal member disposed on the front end side, a valve body configured and arranged to come into contact with and to be separated from the seal member, and a spring member configured to bias the valve body in a first direction toward the seal member,
wherein the valve is brought into a closed state by bringing the valve body into contact with the seal member by the spring member, thereby bringing the internal flow path into the fluid non-communication state,
wherein the cap includes a projection configured to press the valve body in a second direction opposite to the first direction in the sealed state, the projection having a projection end portion facing the valve body in the sealed state,
wherein, at least in the sealed state, the valve is brought into an open state by the valve body being pressed in the second direction by the projection and being separated from the seal member, thereby bringing the internal flow path into the fluid communication state,
wherein in a detachment process of detaching the cap from the ink outlet forming portion, in the unsealed state, the projection end portion takes a valve-closed position at which the valve is in the closed state, the valve-closed position being a position with respect to the ink outlet forming portion in an axial direction along the first direction, and
wherein the cap includes a snap-fit portion configured to be locked to the ink outlet forming portion by a snap-fit in the sealed state.

2. The ink replenishment container according to claim 1, wherein
the cap is connected to the ink outlet forming portion via a hinge.

3. The ink replenishment container according to claim 1,
wherein when the cap is switched from the sealed state to the unsealed state, the projection end portion takes a valve-open position at which the valve is in the open state, the valve-open position being a position with respect to the ink outlet forming portion in the axial direction, and
wherein the valve-open position is located farther in the second direction than the valve-closed position in the axial direction.

4. The ink replenishment container according to claim 1,
wherein the cap includes a tubular side wall,
wherein the ink outlet forming portion includes a tubular base end portion located farther in the second direction than the outlet opening,
wherein the snap-fit portion includes a locking portion formed over an entire perimeter of an inner peripheral surface of the side wall, and
wherein the base end portion includes a locked portion formed over an entire perimeter of an outer peripheral surface of the base end portion and configured to be locked to the locking portion.
